(19) United States
(12) Patent Application Publication
(10) Pub. No.: US 2016/0105059 A1
(43) Pub. Date: Apr. 14, 2016

(54) ROTOR OF A ROTARY ELECTRICAL MACHINE, AND ROTARY ELECTRICAL MACHINE COMPRISING A ROTOR OF THIS TYPE

(71) Applicant: VALEO EQUIPEMENTS ELECTRIQUES MOTEUR, Creteil Cedex (FR)

(72) Inventors: Khadija EL BARAKA, Bussy St Georges (FR); Svetislav JUGOVIC, Juvisy-sur-Orge (FR); Lilya BOUARROUDJ, Charenton Le Pont (FR); Mamy RAKOTOVAO, Vitry Sur Seine (FR)

(21) Appl. No.: 14/894,759

(22) PCT Filed: Jun. 2, 2014
(86) PCT No.: PCT/FR2014/051294

§ 371 Date: Nov. 30, 2015

(30) Foreign Application Priority Data
Jun. 5, 2013 (FR) 1355146

(51) Int. Cl. H02K 1/27; H02K 1/02

(52) U.S. Cl. CPC H02K 1/2773; H02K 1/02

(57) ABSTRACT

A rotor which includes a plurality of permanent magnets arranged in first recesses which extend axially and are regularly distributed between a circumferential portion and a central portion of the magnetic body of the rotor, such as to define a plurality of circumferential polar sections. The magnets each comprise a first portion close to the circumferential portion, wherein the first portion is adjacent to a second portion close to the central portion, the first portion having a first rectangular radial section with a first predetermined width in a circumferential direction and the second portion having a second rectangular radial section with a second predetermined width in a circumferential direction, the second width being smaller than the first width. According to the invention, the rotor also includes a plurality of second recesses which extend axially and are each arranged between two example consecutive magnets at the second portion thereof.

### TECHNICAL FIELD OF THE INVENTION

The present invention relates to a rotor with permanent magnets which is designed for a rotary electrical machine.

The invention also relates to a rotary electrical machine comprising a rotor of this type, in particular for applications such as electric traction motors in electric and hybrid motor vehicles.

### TECHNOLOGICAL BACKGROUND OF THE INVENTION

As a result of their increased performance in terms of output and specific power and power density, synchronous machines with permanent magnets nowadays have extensive application in the field of motor vehicles.

These electrical machines can be produced with a wide range of powers and speeds, and have applications both in vehicles of the “all-electric” type and in vehicles with low CO₂ emission of the type known as “mild hybrid” and “full hybrid”.

Mild-hybrid applications generally concern electrical machines of approximately 8 to 15 kW, for example an electric motor which is fitted on the front face of a thermal engine, and is coupled to it by a drive belt. With an electric motor of this type, it is possible to reduce the capacity of the thermal motorisation (engine downsizing) by providing electric torque assistance which supplies additional power, in particular during restarting. In addition, fraction at low speed, for example in an urban environment, can also be ensured by this same electric motor.

Applications of the full-hybrid type generally concern motors of 30 to 50 kW, for architectures of a series and/or parallel type, with the level of integration which is more refined than that of the electric motor(s) in the traction chain of the vehicle.

The remarkable performance of the present machines with permanent magnets is to a large extent due to the development of rare earth magnets, such as magnets of the neodymium-iron-boron (NeFeB), samarium-iron (SmFe), or samarium-cobalt (SmCo) type, which can have remanences exceeding that of a Tesla.

However, machines with permanent magnets comprising a rotor with a so-called “flux concentration” structure have for a long time made it possible to obtain substantial magnetic fluxes using magnets with lower remanence, for example magnets obtained from sintered or bonded ferrites.

Since an unfavourable geo-political situation has given rise to a strong increase in the cost of rare earth magnets, implementation exclusively of this type of magnet in a rotor of an electrical machine designed for motor vehicle applications is no longer economically viable, and the use of ferrites has recently once more become the focus of attention.

However, since the remanence of a ferrite is lower than that of a rare earth magnet, it is necessary to increase the volume of the ferrite magnet in order to obtain an equivalent magnetic flux.

With this magnetic constraint imposed, it will be appreciated that the volume of the ferrite magnets cannot be increased indefinitely in a rotor with a given size.

In the international application WO2013060096 by the company VALEO EQUIPEMENT ELECTRIQUES MOTEUR, it is proposed to provide the magnets with a substantially trapezoidal form in the direction of the axis of the rotor, such as to maximise the volume of ferrite in the rotor, and consequently maximise the electrical performance of the machine.

However, the complex form of the magnets tends to increase the production costs, and lose the benefit of the lower cost of the ferrites.

In addition, the shape in the form of a wedge of the magnets, which leaves in the magnetic mass of the rotor between the magnets only a thin partition in order to retain the polar sections radially, tends to detract from the mechanical resistance of the rotor to the centrifugal forces.

### GENERAL DESCRIPTION OF THE INVENTION

The aim of the present invention is thus to optimise the volume of the magnets of a rotor, in order to maximise the performance of the machine in accordance with the perspective opened up by the teaching of the aforementioned prior application by the applicant company, whilst eliminating certain disadvantages of the structure of the prior rotor.

Specifically, its objective is a rotor of a rotary electrical machine comprising a plurality of alternating north poles and south poles formed from a plurality of permanent magnets arranged in first recesses.

These first recesses extend axially, and are distributed regularly between a circumferential part and a central part of the magnetic mass of the rotor, such as to define a plurality of circumferential polar sections.

The permanent magnets of the type of rotor in question each comprise a first part close to the circumferential part adjacent to a second part close to the central part, the first part having a first rectangular radial section with a first predetermined width in a circumferential direction, and the second part having a second rectangular radial section with a second predetermined width in a circumferential direction, the second width being smaller than the first width.

According to the invention, the rotor additionally comprises a plurality of second recesses which extend axially, and are each arranged between two consecutive examples of the magnets at the second part.

These second recesses advantageously delimit pairs of ribs which extend axially and retain the polar sections radially.

Alternatively or simultaneously, the second recesses preferably each have a substantially triangular radial cross section.

In the rotor for a rotary electrical machine according to the invention, the magnets are advantageously each in the form of an assembly in a single piece, preferably constituted by moulded ferrite.

Alternatively, preferably, the first part is formed by a first magnetised bar, and the second part is formed by a second magnetised bar.

The first and second magnetised bars are advantageously constituted by ferrite, but alternatively the first magnetised bar is highly advantageously constituted by ferrite and the second magnetised bar is constituted by a material comprising at least one rare earth, and preferably neodymium.

Advantage will be derived from the fact that the circumferential part is open radially, at least partially, opposite the permanent magnets.

The invention also relates to a rotary electrical machine comprising a rotor with the above characteristics.

These few essential specifications will have made apparent to persons skilled in the art the advantages provided by the rotor for a rotary electrical machine according to the invention, as well as by the corresponding electrical machine, in comparison with the prior art.

The detailed specifications of the invention are provided in the description which follows in association with the appended drawings. It should be noted that these drawings serve the purpose simply of illustrating the text of the description, and do not constitute in any way a limitation of the scope of the invention.

### BRIEF DESCRIPTION OF THE DRAWINGS

FIG. 1 shows a simplified view in radial cross section of a rotor with permanent magnets according to the invention.

### DESCRIPTION OF THE PREFERRED EMBODIMENTS OF THE INVENTION

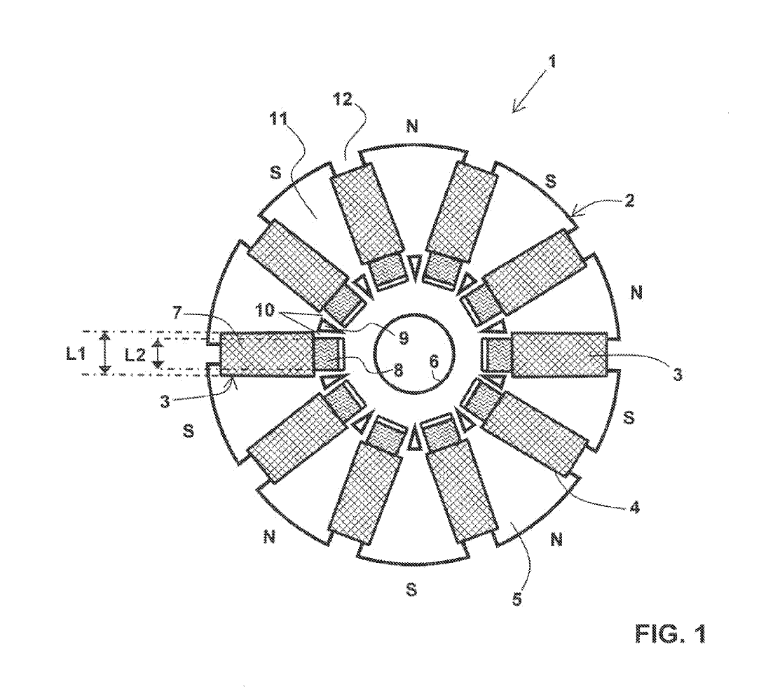

According to a preferred embodiment of the invention represented in FIGURE 1, the simplified radial cross-section of a rotor 1 with permanent magnets shows clearly the arrangement in the magnetic mass 2 of the permanent magnets 3 in first recesses 4 which are distributed regularly between a circumferential part 5 and a central part 6, such as to form a plurality of alternating north poles N and south poles S.

A specific embodiment of a machine comprising a rotor of this type is for example an 8 to 15 kW motor/generator for applications in motor vehicles of the so-called mild-hybrid type.

In its mode in which it is functioning as a motor, this machine can be designed for starting of the thermal engine, for torque assistance for the thermal engine, as well as for electric traction of the vehicle at low speed.

According to a particular embodiment of this machine, a rotor 1 comprising ten permanent magnets 3 rotates inside a stator (not represented) with a plurality of notches.

The stator and the rotor 1 are produced in a conventional manner with sets of metal plates forming magnetic masses 2.

The notches of the stator are designed to receive stator windings (not represented), and form between one another a plurality of stator teeth. According to the embodiments, the notches will be designed to accommodate concentrated windings which are wound on large teeth, or distributed windings.

A stator current passes through the stator windings which create a rotary magnetic field which drives the rotor 1. The motor torque supplied depends in particular on the intensity of the stator current and of the magnetic flux in the rotor 1.

As explained in the preamble, the replacement of the rare earth magnets by ferrite magnets requires more voluminous magnets in order to obtain a similar magnetic flux in the rotor 1.

For the purpose of maintaining the same motor torque for the same stator intensity, the volume of the ferrite magnets must therefore be maximised.

A solution to this problem, already proposed by the applicant company, consists of implementing bevelled magnetised bars in the vicinity of the central part 6 of the rotor 1.

As already indicated in the preamble, this solution has disadvantages from the point of view of manufacturing costs and from the mechanical point of view, and is not optimum.

In order to maximise the volume of the magnets 3, whilst eliminating the aforementioned disadvantages, the invention thus proposes to provide the magnets 3 with a stepped form.

Thus, the magnets 3 occupy a large volume of the magnetic mass 2 of the rotor 1, both in the vicinity of the circumferential part 5, and in the vicinity of the central part 6, as shown clearly in FIGURE 1.

This stepped form is advantageously provided by magnets 3 each comprising a first part 7 close to the circumferential part 5 of the rotor 1 adjacent to a second part 8 close to the central part 6.

The first part 7 is formed by a first magnetised bar having a first rectangular straight section, and the second part 8 is formed by a second magnetised bar which is juxtaposed radially relative to the first in the direction of the central part 6.

The magnetised bars 7, 8 with a rectangular section are standard industrial supplies which are manufactured in large quantities in different dimensions and various materials, according to the remanent magnetisation required per industry.

The manufacture of the rotor 1 thus benefits from economies of scale derived from the production in a very large series of its main element.

The second magnetised bar 8 which is the closest to the central part 6 has a second width L2 (in a circumferential direction) which is smaller than a first width L1 of the first magnetised bar 7.

As shown clearly in FIGURE 1, second recesses 9 are arranged between the magnets 3 at their second part 8.

These second recesses 9, with a substantially triangular straight cross-section, delimit pairs of ribs 10 which retain a plurality of circumferential polar sections 11 radially between the magnets 3.

The doubling of the retention elements 10 of the polar sections 11 compared with the single tongue situated between the magnets according to the prior art makes possible an increase in the resistance of the rotor 1 to the centrifugal forces.

In addition, these second recesses 9 contribute towards the control of the magnetic field in the rotor 1.

For the same purpose, the first recesses 4 of the rotor 1 according to the invention preferably comprise openings 12 towards the periphery of the magnetic mass 2.

These openings have the effect of increasing the reluctance of these parts of the magnetic circuit, and thus of limiting the leakage flux of the magnets 3, whilst contributing towards the decrease in the mass of the circumferential part 5 of the rotor 1, which makes it possible to increase the mass of the magnets 3, whilst remaining within the limit of the mechanical stresses withstood by the ribs 10.

The first magnetised bar 7, which is the most voluminous one, advantageously consists of ferrite, whereas the second magnetised bar 8, which is less voluminous, can be of a rare earth type, in particular neodymium, without having a great effect on the cost.

Alternatively, the first and second magnetised bars 7, 8 both consist of ferrite for the less demanding applications.

Also alternatively, in particular applications, the magnets 3 are in the form of a moulded ferrite assembly in a single piece. In co-operation with the triangular form of the second recesses 9, the stepped form of the magnets 3 according to the invention makes it possible to create pairs of ribs 10 which are indispensable for the reinforcement of the mechanical strength of the rotor 1.

It will be appreciated that the invention is not limited simply to the above-described preferred embodiments.

Other embodiments based on stepped forms which are more complex than those specified above would not depart from the context of the present invention, provided that they are derived from the following claims.

1. Rotor (1) of a rotary electrical machine comprising a plurality of alternating north (N) poles and south poles (S) formed from a plurality of permanent magnets (3) arranged in first recesses (4) which extend axially, and are distributed regularly between a circumferential part (5) and a central part (6) of the magnetic mass (2) of said rotor (1), such as to define a plurality of circumferential polar sections (11), said permanent magnets (3) each comprising a first part close (7) to said circumferential part (5) adjacent to a second part (8) close to said central part (6), said first part (7) having a first rectangular radial section with a first predetermined width (L1) in a circumferential direction, and said second part (8) having a second rectangular radial section with a second predetermined width (L2) in a circumferential direction, said second width (L2) being smaller than said first width (L1), wherein it additionally comprises a plurality of second recesses (9) which extend axially, and are each arranged between two consecutive examples of said magnets (3) at said second part (8).

2. Rotor (1) of a rotary electrical machine according to claim 1, characterised in that said second recesses (9) delimit pairs of ribs (10) which extend axially and retain said polar sections radially (11).

3. Rotor (1) of a rotary electrical machine according to claim 1, characterised in that said second recesses (9) each have a substantially triangular radial cross section.

4. Rotor (1) of a rotary electrical machine according to claim 1, characterised in that said magnets (3) are each in the form of an assembly in a single piece, preferably constituted by moulded ferrite.

5. Rotor (1) of a rotary electrical machine according to claim 1, characterised in that said first part (7) is formed by a first magnetised bar, and said second part (8) is formed by a second magnetised bar.

6. Rotor (1) of a rotary electrical machine according to claim 5, characterised in that said first and second magnetised bars (7, 8) are constituted by ferrite.

7. Rotor (1) of a rotary electrical machine according to claim 5, characterised in that said first magnetised bar (7) is constituted by ferrite and said second magnetised bar (8) is constituted by a material comprising at least one rare earth, and preferably neodymium.

8. Rotor (1) of a rotary electrical machine according to claim 1, characterised in that said circumferential part (5) is open radially, at least partially, opposite said permanent magnets (3).

9. Rotary electrical machine, characterised in that it comprises a rotor (1) according to claim 1.

10. Rotor (1) of a rotary electrical machine according to claim 2, characterised in that said magnets (3) are each in the form of an assembly in a single piece, preferably constituted by moulded ferrite.

11. Rotor (1) of a rotary electrical machine according to claim 3, characterised in that said magnets (3) are each in the form of an assembly in a single piece, preferably constituted by moulded ferrite.

12. Rotor (1) of a rotary electrical machine according to claim 2, characterised in that said first part (7) is formed by a first magnetised bar, and said second part (8) is formed by a second magnetised bar.

13. Rotor (1) of a rotary electrical machine according to claim 3, characterised in that said first part (7) is formed by a first magnetised bar, and said second part (8) is formed by a second magnetised bar.

14. Rotor (1) of a rotary electrical machine according to claim 2, characterised in that said circumferential part (5) is open radially, at least partially, opposite said permanent magnets (3).

15. Rotor (1) of a rotary electrical machine according to claim 3, characterised in that said circumferential part (5) is open radially, at least partially, opposite said permanent magnets (3).

16. Rotor (1) of a rotary electrical machine according to claim 4, characterised in that said circumferential part (5) is open radially, at least partially, opposite said permanent magnets (3).

17. Rotor (1) of a rotary electrical machine according to claim 5, characterised in that said circumferential part (5) is open radially, at least partially, opposite said permanent magnets (3).

18. Rotor (1) of a rotary electrical machine according to claim 6, characterised in that said circumferential part (5) is open radially, at least partially, opposite said permanent magnets (3).

19. Rotor (1) of a rotary electrical machine according to claim 7, characterised in that said circumferential part (5) is open radially, at least partially, opposite said permanent magnets (3).
